(19) United States
(12) Patent Application Publication
(10) Pub. No.: US 2023/0093794 A9
(43) Pub. Date: Mar. 23, 2023

(54) VIEW REDIRECTING SYSTEM

(71) Applicant: JOHN POSTON, San Antonio, TX (US)

(72) Inventor: JOHN POSTON, San Antonio, TX (US)

(21) Appl. No.: 17/000,335

(22) Filed: Aug. 23, 2020

Related U.S. Application Data
(60) Provisional application No. 62/890,965, filed on Aug. 23, 2019.

(51) Int. Cl. G02B 17/02; G02B 17/00; G02B 7/182; H04N 5/225

(52) U.S. Cl. CPC G02B 17/026; G02B 17/008; G02B 7/182; H04N 5/2252; B62J 29/00

(57) ABSTRACT

A view redirecting system for use on a mobility device to redirect a user's view to a more favorable orientation is disclosed. One embodiment includes a first structure having a convex first reflective surface, a second structure having a flat second reflective surface and a third structure. The third structure being an adjustable structure and configured for connecting said first and second structures together. The first structure and the second structure are configured to be positioned such that the first reflective surface and the second reflective surface are facing each other at angle up to and including ninety degrees. The third structure configured to maintain the angle. The system is arranged to redirect a user's view from a first line-of-sight to a second line-of-sight by light interacting with the reflective surfaces The system being configured for attachment to a structural member of the mobility device.

### CROSS-REFERENCE TO RELATED APPLICATIONS

This application claims the benefit of U.S. Provisional Application No. 62/890,965 filed Aug. 23, 2019 and which is incorporated herein by reference.

### TECHNICAL FIELD

The field to which the disclosure generally relates includes the redirecting of a user's field of view.

### BACKGROUND

Stationary devices, walkers, bicycles, or other mobility devices may assist a user in standing, sitting, walking, performing daily activities, or the like. Mobility devices often do not account for assistance needs relating to seeing, hearing, or other sensory related needs as well as needs associated with assisting the musculoskeletal system of a user. A need exists for products at the intersection between user sensory needs and musculoskeletal system assistance. For example, stooped or hunchbacked wheelchair or walker users may have difficulty seeing directly in front of themselves if their posture makes it difficult to lift their head and see forward. Some of the prior solutions to this problem attempt to assist in correcting the posture of the user. These solutions fail to meet the needs of the industry because it can be difficult, very painful, or impossible for a user to raise their head to see very far in front of themselves.

As a non-limiting example, it is desirable to have a device for stooped or hunchbacked users that provides a robust field of view in front of themselves while using mobility devices. It is desirable to have a device that allows the user to adjust their field of view to suit their specific needs. It is desirable to have a device that is easy to use and dependable, especially for the elderly and handicapped persons who depend upon a clear view of their environment to prevent falls and injuries. It is contemplated that a view redirecting system may also have applications on various devices and fixtures, such as on bicycles, to allow the user or rider to see forward when leaning over. The disclosed device advantageously fills these needs and addresses the aforementioned deficiencies by providing an adjustable robust view in front of users such that they can then confidently navigate as needed.

### SUMMARY OF ILLUSTRATIVE VARIATIONS

A view redirecting system may include a first structure having a flat first reflective surface; a second structure having a convex second reflective surface; wherein the first structure and the second structure are positionable with respect to each other such that the first reflective surface and the second reflective surface face each other at an angle of about ninety degrees or less and wherein the view redirecting system is constructed and arranged to redirect a user's line-of-sight from an approximately vertical direction to an approximately horizontal direction.

A view redirecting system may include a single-piece, continuous structure. The view redirecting system may further include a first reflective surface affixed to the single-piece, continuous structure; a second reflective surface affixed to the single-piece, continuous structure and wherein the first reflective surface and the second reflective surface are about facing one another at an angle of about ninety degrees or less and wherein the view redirecting system is constructed and arranged to redirect a user's line-of-sight from an approximately vertical direction to an approximately horizontal direction.

A view redirecting system may include a camera assembly that may include a display screen and a video camera, the display screen and video camera being in communication. The view redirecting system may include a first structure wherein the display screen may be mounted on the first structure. The view redirecting system may further include a mounting device. The view redirecting system is constructed and arranged to redirect a user's line-of-sight from an approximately vertical direction to an approximately horizontal direction

Other illustrative variations within the scope of the invention will become apparent from the detailed description provided herein. The detailed description and enumerated variations, while disclosing optional variations, are intended for purposes of illustration only and are not intended to limit the scope of the invention.

### BRIEF DESCRIPTION OF THE DRAWINGS

Examples of variations within the scope of the invention will become more fully understood from the detailed description and the accompanying drawings, wherein:

FIG. 1 depicts one variation of an adjustable view redirecting system affixed to a mobility device such as a walker, wheelchair, or rollator;

FIG. 2 depicts one variation of an adjustable view redirecting system affixed to a mobility device such as a walker, wheelchair, or rollator;

FIG. 3 depicts one variation of an adjustable view redirecting system and the redirected line-of-sight of a user;

FIG. 4 depicts one variation of an adjustable view redirecting system affixed to a mobility device such as a walker, wheelchair, or rollator including an extendable arm and the redirected line-of-sight of a user;

FIG. 5 depicts one variation of a view redirecting system that may include a single-piece, continuous structure;

FIG. 6 depicts one variation of a view redirecting system affixed to a mobility device such as a walker, wheelchair, or rollator that may include a camera assembly;

FIG. 7 depicts one variation of a view redirecting system that may include a continuous structure affixed to a mobility device such as a walker, wheelchair, or rollator including an extendable arm with hinged attachment; and

FIG. 8 depicts one variation of a view redirecting system comprising a single-piece, continuous structure affixed to a mobility device such as a bicycle.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are within the scope of the invention.

A number of variations may include a product such as a view redirecting system that may include a first reflective surface approximately opposite a second reflective surface by way of at least one structure, both reflective surfaces facing each other at an angle of about ninety degrees or less and both reflective surfaces typically of approximately the same size. The angle at which the reflective surfaces interact and redirect the field of view of a user is adjustable. The second of the reflective surface's structures may be hard mounted to a walker or other mobility device with a mounting bracket or mounting device. Alternatively, the view redirecting system may be supported by a single, continuous structure. This structure may be mountable to a walker or other mobility device. The view redirecting system may be constructed and arranged to allow a user who is looking down or towards the ground to redirect their view forward towards the horizon by way of at least one reflective surface. The reflective surface angle is chosen to allow the viewer to see the most complete view looking forward when mounted on the walker or other mobility device. The second of the reflective surface structure attaches to the medical walker or other mobility device via a clamp or other mounting device. The positioning of the mounting angle on the walker or other mobility device is chosen to optimize the view for the user. The view redirecting system can also be attached to a stationary device.

The device may also include hinged joints on both the first reflective surface and the second reflective surface allowing each reflective surface to be pivotable relative to the other reflective surface. The view redirecting system may include hinge extension linkages to extend the pivot points away from the adjacent reflective surface or mounting bracket pivot points. The view redirecting system may include locking or non-locking adjustable hinges on each pivot point to allow for adjusting the position of each individual reflective surface and the mounting bracket. The first and second reflective surfaces can be either a flat, concave, or convex reflective surface. The view redirecting system may also utilize extension linkages and locking knobs as described above to allow for adjustment of the second reflective surface relative to the second mounting bracket. A mounting device such as pipe saddle type clamps or other mounting means may attach the view redirecting system to a mobility device or structure. Alternatively, the mounting device may attach to one or more swing arms that attach to the mobility device at a more distal location and allow the reflective surface assembly to swing into place and then swing out of the way when not needed or desired.

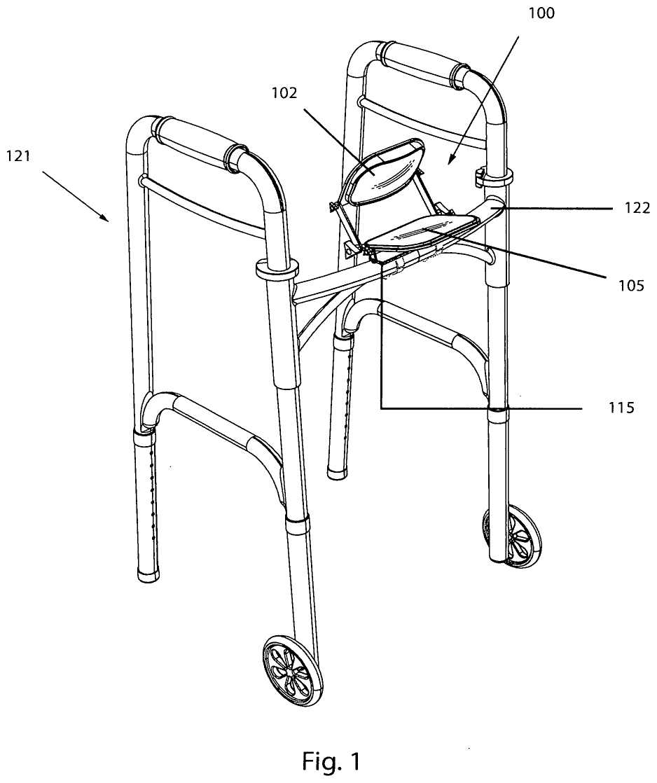

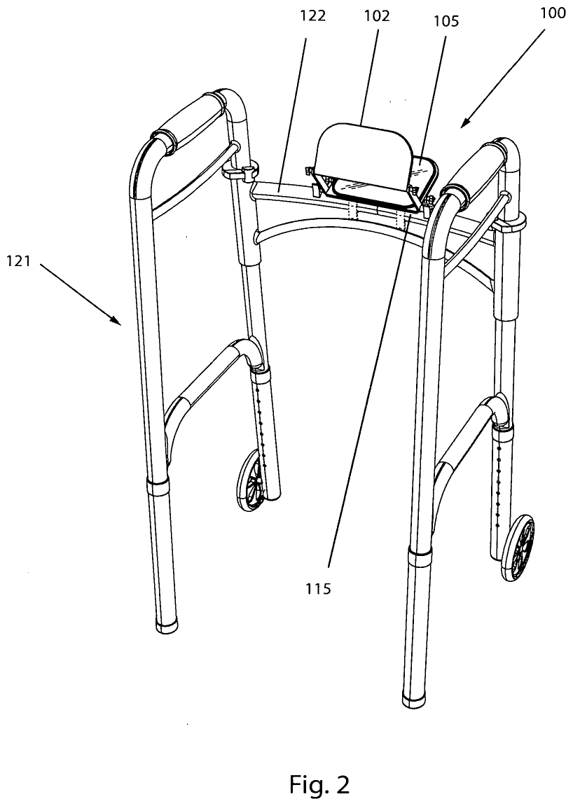

Referring to FIGS. 1 and 2, a view redirecting system 100 may be attached to a mobility device 121. The view redirecting system 100 may include a first reflective surface 102 pivotably attached to second reflective surface 105, and mounting device 115. The mounting device 115 may be constructed and arranged to facilitate the attachment of the view redirecting system 100 to a structural member 122 of the mobility device 121. The view redirecting system 100 may be constructed and arranged to redirect a user's line-of-site from an approximately vertical direction to an approximately horizontal direction while also preventing a user's line-of-sight from appearing “flipped” horizontally or vertical as with traditional, single reflective surfaces. The view redirecting system 100 may be constructed and arranged to provide a wide angle redirected line-of-sight via a convex reflective surface.

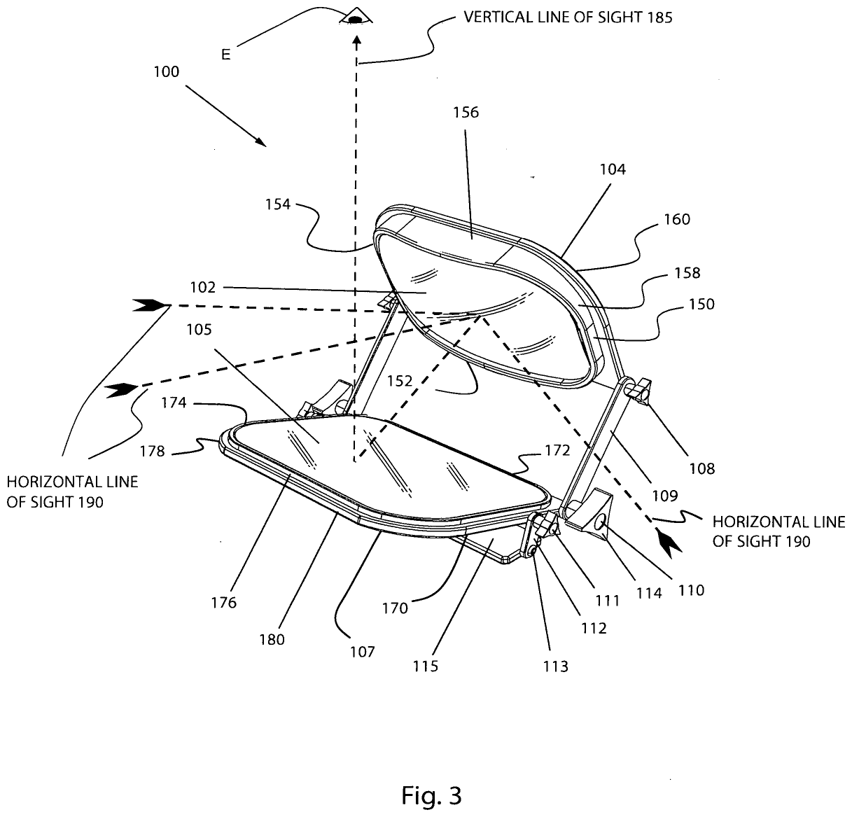

Referring to FIG. 3, a view redirecting system 100 may include a first structure or structure 104 pivotably attached to at least one arm 109. The at least one arm 109 may be a rigid, elastic, or adjustable or positionable flexible arm. As non-limiting examples, the at least one arm 109 may assume a variety of shapes, sizes, and configurations, and the number of sides, edges, beveled edges, corners, arcs, etc. may vary and still fall within the scope of this disclosure. Due to the oblique view of FIG. 3, only one side of the view redirecting system 100 is clearly visible. The following items are on both sides of view redirecting system 100: 108, 109, 110, 111, 112, 113, and 114. A first reflective surface 102 may be disposed on the first structure 104. The first structure 104 may include a back 160, a first side 150, a second side 152, a third side 154, and a fourth side 156. The first structure 104 may include at least one beveled side 158 structurally transitioning the first side 150 to the second side 152, the second side 154 to the third side 156, and the third side 156 to the fourth side 158 or any combination thereof. However, it is contemplated that the first structure may assume a variety of shapes, sizes, and dimensions and the configuration shown in FIG. 3 shall not be considered limiting. As non-limiting examples, the first structure may be generally rectangular, circular, triangular, trapezoidal, hexagonal, etc., and the number of sides, edges, beveled edges, corners, arcs, etc. may vary and still fall within the scope of this disclosure. A first adjustable hinge 108 may be constructed and arranged to tighten and loosen the pivotal attachment of the first structure 104 and the at least one arm 109. A second adjustable hinge 110 may be constructed and arranged to tighten and loosen the pivotal attachment of a second structure 107 and the at least one arm 109. A second reflective surface 105 may be disposed on a second structure 107. The second structure 107 may include a second back 180, a first side 170, a second side 172, a third side 174, and a fourth side 176. The second structure 107 may include at least one beveled side 178 structurally transitioning the fourth side 176 to the third side 174, the third side 174 to the second side 172, and the second side 172 to the first side 170 or any combination thereof. However, it is contemplated that the first structure may assume a variety of shapes, sizes, and dimensions and the configuration shown in FIG. 3 shall not be considered limiting. As non-limiting examples, the second structure may be generally rectangular, circular, triangular, trapezoidal, hexagonal, etc. and the number of sides, edges, beveled edges, corners, arcs, etc. may vary and still fall within the scope of this disclosure. The second structure 107 may be pivotably attached to at least one mounting arm 112 via a third adjustable hinge 111. Any of the first, second, and third adjustable hinges may assume a variety of shapes, sizes, and configurations, and the number of sides, edges, corners, beveled edges, corners, arcs, etc. may vary and still fall within the scope of this disclosure. It is contemplated that any of the first, second, and third adjustable hinges may include user tightenable nut and bolt assemblies, friction, tension, or torque hinges or joints, or hinges relying on various other means for resistance. Any of the first, second, and third adjustable hinges may include a tightening mechanism 114 such as a hand-tightened nut or similar. A mounting device 115 may be pivotably attached to the at least one mounting arm via an attachment 113. The attachment 113 may be a rigid attachment or structure, a pivot pin, nut and bolt assembly, screw, or any other mechanical configuration permitting the mounting device 115 to be pivotably attach to the at least one mounting arm 112. The mounting device 115 may assume a variety of shapes, forms, sizes, and dimensions and the configurations shown in the figures shall not be considered limited. As examples, the mounting device 115 may be a plate, one or a plurality of clamps, magnets, nut and bolt combinations, screws, grips, adhesives, etc. In practice and in use, a user's line-of-site (E) may be redirected from an approximately vertical direction to an approximately horizontal direction. As shown in FIG. 3, the first or second reflective surface may be generally convex in shape and thus may redirect a user's line-of-sight from an approximately vertical direction to an approximately horizontal direction as well as providing a wide angle of redirected sight.

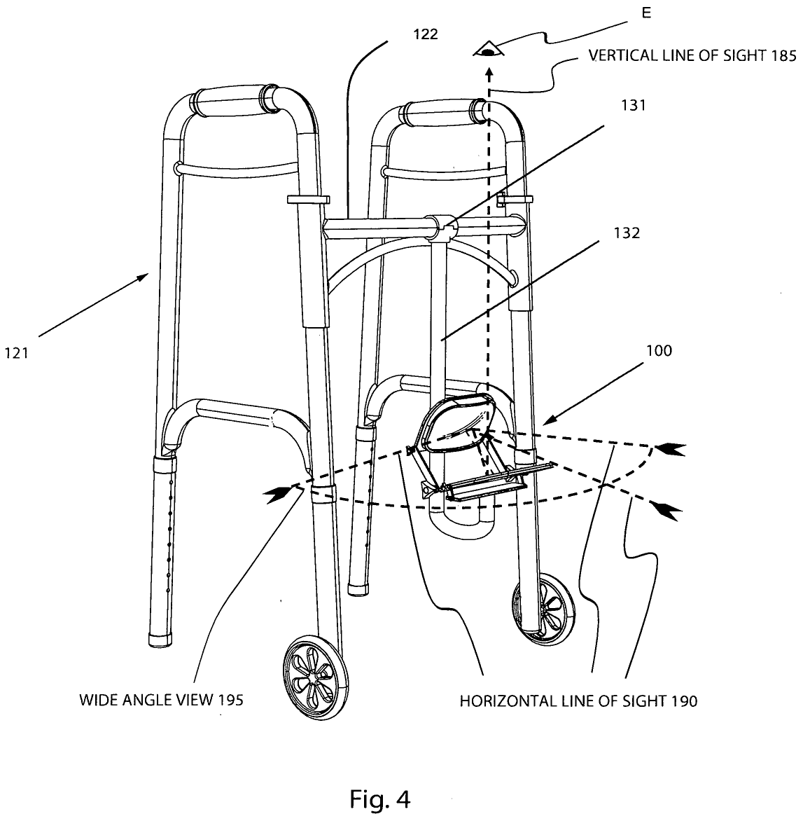

Referring to FIG. 4, a view redirecting system 100 may include an extension arm 132 constructed and arranged to attach the view redirecting system 100 to a structural member 122 or a mobility device 121 via an extension arm mounting device 131. The extension arm 132 may be constructed and arranged to displace the view redirecting system 100 from the mobility device 121 and may increase a user's capacity to observe their own feet or the ground in their field of view while also redirecting a user's line-of-sight (E) from an approximately vertical direction to an approximately horizontal direction. The first or second reflective surfaces may be generally convex in shape and thus may redirect a user's line-of-sight approximately vertical direction to an approximately horizontal direction as well as providing a wide angle view 195.

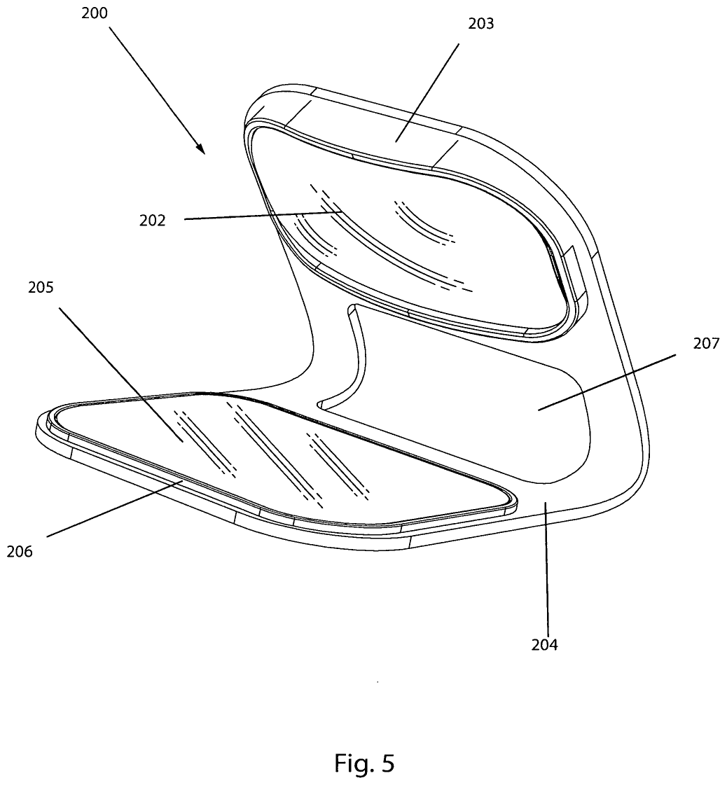

Referring to FIG. 5, the view redirecting system may be a view redirecting system 200. A single-piece, continuous structure 204 may be attached to first structure 203 and second structure 206 as shown. First reflective surface 202 may be attached to first structure 203 and second reflective surface 205 may be attached to second structure 206. Alternatively, the single-piece, continuous structure 204 may comprise and define the first structure and the second structure and in this way the first reflective surface 202 and the second reflective surface 205 may be affixed directly to the continuous structure 204. The continuous structure 204 may define a cutout 207 of any size or shape but which may be generally rectangular.

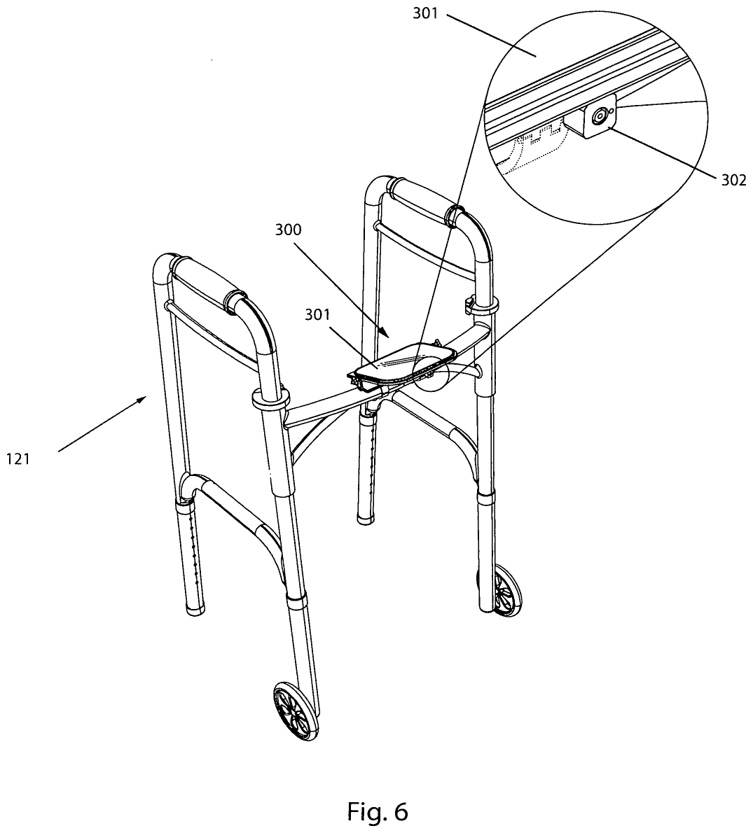

Referring to FIG. 6, the view redirecting system may include a camera assembly 300. The video camera assembly 300 may have a display screen 301 and a video camera 302 mounted beneath the display screen. Alternatively, it is contemplated that the camera assembly may include devices and smart devices such as tablet computers, handheld computers including smartphones, or other similar devices. Display screen 301 may be pivotably attached to short hinge extension arm by third adjustable hinge and to attachment which pivotably attaches to a mounting device 303 as previously described herein. Due to the oblique view of the video camera assembly 300 in FIG. 6, only one side of the assembly is visible. The hinge and pivot hardware are on both sides of the video camera assembly 300. The video camera assembly 300 may be in communication with the display screen 301 such that video or photos captured by the video camera assembly 300 may be displayed on the display screen 301 in real time. Alternatively, the view redirecting system 100 may be constructed and arranged to redirect the line-of-sight of an integrated camera of a smart device such as a smart phone, computer tablet, etc. from an approximately vertical direction to an approximately horizontal direction as well as providing a “wide angle” of view much in the same way line-of-sight (E) is depicted in FIGS. 3 and 4. For example, the view redirecting system 100 may be located approximately below a smart device such as a smart phone, computer tablet, etc. such that a camera that is located on the back of the smart device is pointed approximately at one of the first or second reflective surfaces of the view redirecting system 100. In this way, the camera's line-of-sight may be redirected from an approximately vertical direction to an approximately horizontal direction such that the horizontal line-of-sight is displayed on the smart device's screen despite having the camera pointed approximately vertically towards the ground.

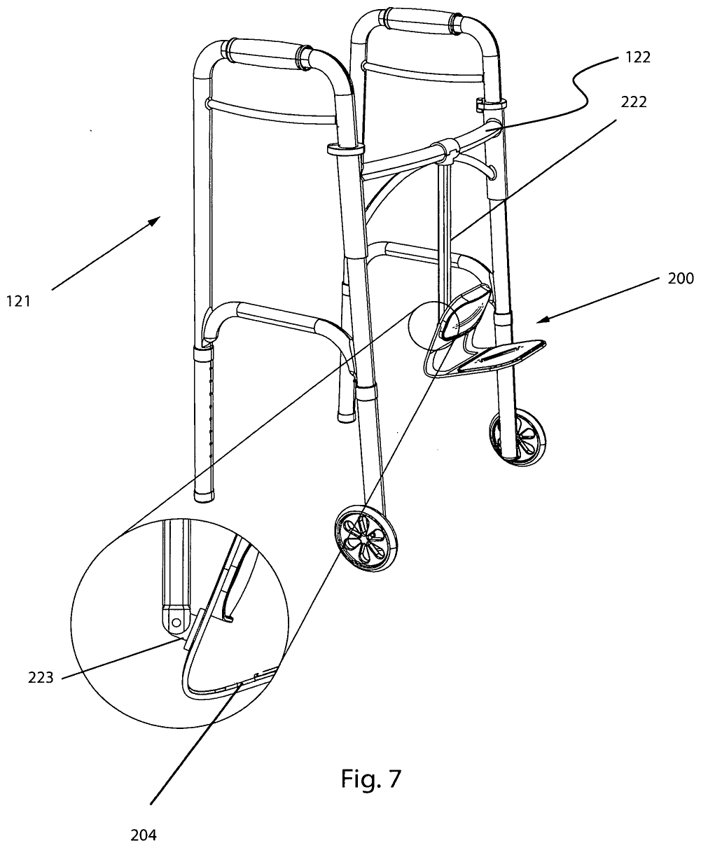

Referring to FIG. 7, a view redirecting system 200 including a single-piece, continuous structure 204 may include an extension arm 222 constructed and arranged to attach the view redirecting system 200 to a structural member 122 or a mobility device 121. The extension arm 222 may be constructed and arranged to further displace the view redirecting system 200 from the mobility device 121 and may include an adjustable hinge 223 such that the view redirecting system may pivot to adjust for user preference.

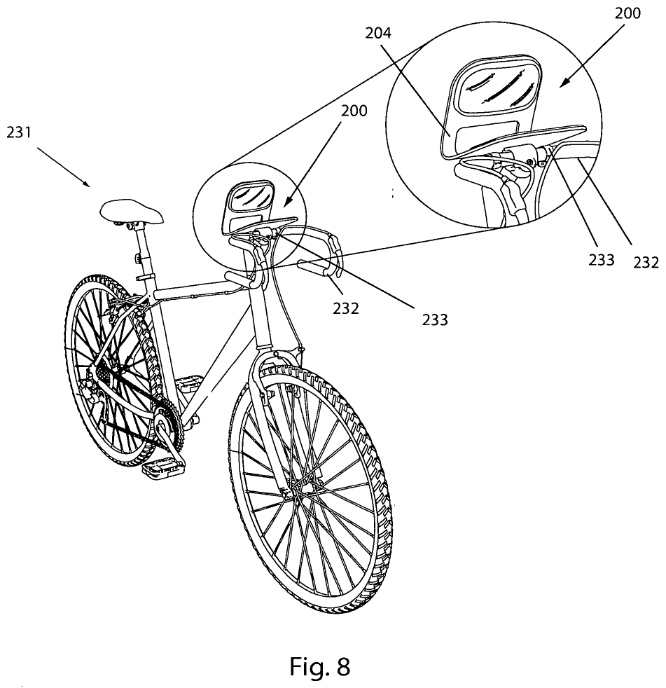

Referring to FIG. 8, a view redirecting system 200 including a single-piece, continuous structure 204 may be affixed to a bicycle 231 or the handlebars 232 of a bicycle 231 by mounting device 233. Due to the view on FIG. 8, the mounting hardware is not clearly visible. The mounting hardware is symmetrical on both sides of view redirecting system 200. The mounting device 233 may be a receptacle constructed and arranged to receive a camera assembly such as devices and smart devices such as tablet computers, handheld computers including smartphones, or other similar devices.

According to variation 1, a view redirecting system may include a first structure comprising a convex first reflective surface; a second structure comprising a flat second reflective surface; wherein the first structure and the second structure are positionable with respect to each other such that the first reflective surface and the second reflective surface face each other at an angle of about ninety degrees or less and wherein the view redirecting system is constructed and arranged to redirect a user's view from an approximately vertical line-of-sight 185 to an approximately horizontal line-of-sight 190.

Variation 2 may include a product as set forth in variation 1 and may further include a first adjustable hinge at an attachment of a first structure and at least one arm.

Variation 3 may include a product as set forth in variation 1 or 2 and may further include a second adjustable hinge at an attachment of the second structure and at least one arm.

Variation 4 may include a product as set forth in any of variations 1 through 3 wherein the first adjustable hinge and the second adjustable hinge may be constructed and arranged to facilitate the pivoting of the first structure and the second structure.

Variation 5 may include a product as set forth in any of variations 1 through 4 and may further include a mounting arm, a mounting device, and a third adjustable hinge wherein the mounting arm maybe adjustably fixed to the second structure via a third adjustable hinge and the mounting device maybe pivotably connected to the mounting arm.

Variation 6 may include a product as set forth in any of variations 1 through 5 wherein the mounting device may be constructed and arranged to attach the view redirecting system to a structural member.

Variation 7 may include a product as set forth in variation 6 and may further include an extension arm constructed and arranged to displace the view redirecting system from a structural member or a user.

Variation 8 may include a product as set forth in any of variations 1 through 7 wherein the first structure may include a back, a first side, a second side, a third side, a fourth side, and at least one beveled side structurally transitioning the first side to the second side, the second side to the third side, the third side to the fourth side, at the fourth side to the first side.

Variation 9 may include a product as set forth in any of variations 1 through 8 wherein the second structure may include a back, a first side, a second side, a third side, a fourth side, and at least one beveled side structurally transitioning the first side to the second side, the second side to the third side, the third side to the fourth side, at the fourth side to the first side.

According to variation 10, a view redirecting system may include a single-piece, continuous structure including a convex first reflective surface and a flat second reflective surface wherein the first reflective surface and the second reflective surface may be about facing each other at angle of about ninety degrees or less; and wherein the view redirecting system may be constructed and arranged to redirect a user's view from an approximately vertical line-of-sight 185 to an approximately horizontal line-of-sight 190.

Variation 11 may include a product as set forth in variation 10 and may further include a mounting arm, a mounting device, and at least one adjustable hinge wherein the mounting arm may be adjustably fixed to the continuous structure via the adjustable hinge and the mounting device may be pivotably connected to the mounting arm.

Variation 12 may include a product as set forth in any of variations 10 through 11 wherein the mounting device may be constructed and arranged to attach the view redirecting system to a structural member.

Variation 13 may include a product as set forth in any of variations 10 through 12 and may further include an extension arm constructed and arranged to displace the view redirecting system from a structural member or a user.

Variation 14 may include a product as set forth in any of variations 10 through 13 wherein the continuous structure may include a back, a first side, a second side, a third side, a fourth side, and at least one beveled side structurally transitioning the first side to the second side, the second side to the third side, the third side to the fourth side, at the fourth side to the first side.

Variation 15 may include a product as set forth in any of variations 11 through 14 wherein the continuous structure may define a cutout.

According to variation 16, a view redirecting system may include a camera assembly that may include a display screen and a video camera, the display screen and video camera being in communication. The view redirecting system may include a first structure. The display screen may be mounted on the first structure. The view redirecting system may further include a mounting device. The view redirecting system may be constructed and arranged to redirect a user's view from an approximately vertical line-of-sight 185 to an approximately horizontal line-of-sight 190.

Variation 17 may include a product as set forth in variation 16 and may further include a first plate, wherein the display screen is mounted on the first plate; a mounting arm; and at least one adjustable hinge wherein the mounting arm is adjustably fixed to the first structure via the adjustable hinge and the mounting device is pivotably connected to the mounting arm.

Variation 18 may include a product as set forth in variations 16 through 17 wherein the mounting device may be constructed and arranged to attach the view redirecting system to a structural member.

Variation 19 may include a product as set forth in any of variations 16 through 18 and may further include an extension arm constructed and arranged to displace the view redirecting system from the structural member.

### ADDITIONAL VARIATIONS

Although the descriptions above contain many specificities, these should not be construed as limiting the scope but as merely providing illustrations of some of the presently disclosed embodiments. Many other ramifications, variations, alterations, substitutions, modifications, and the like are enabled by the foregoing disclosure. For example: sizes, shapes, materials, assembly, design, etc., of all parts can be readily modified or changed. View redirecting system can be mounted off the centerline of the mobility device. It can also be mounted forwardly, backwardly, above or below the mobility device handlebars in the case of a bicycle or support structure of a walker, rollator type device or other mobility device. View redirecting system can be constructed such that first reflective surface 102 can be molded or constructed into one piece such that a pivotable connection is part of that structure, second reflective surface can likewise be molded on constructed into one piece such that the pivotable connection is part of that structure; neither the first reflective surface 102 or the second reflective surface 105 require a separate plate for attachment as the back side of both reflective surfaces can provide the structure for their respective pivot points. Arm 109 can be any length and can even be eliminated such that pivot and pivot are connected directly together so as not to need a hinge arm; alternatively the arm 109 can be replaced with a living hinge that holds whatever position it was left in and then pivots and could either be rigid attachment points or they could be eliminated entirely and the flexible hinge could either be molded or constructed as part of the entire assembly. Attachment 113 could eliminated entirely and hinge arm 112 would be molded or fabricated to be part of plate; plate and attachment 113 and arm 112 and adjustable hinge 111 could be eliminated and mounting could be directly to first structure 104 or second structure 107 by mounting device 233 or adjustable hinge 223 or other mounting means; first reflective surface 102 and second reflective surface 105 can be tinted or otherwise made antiglare; extension arm mounting device 131 can be either be able to swivel or be rigidly mounted; extension arm 132 can be attached to view redirecting system 100 on either surface, or to the arm 109. View redirecting system 100 can also be attached to any structural member of mobility device without any additional extension arm 132. View redirecting systems can used interchangeably dependent on the user's preference. View Redirecting System continuous structure 204 could have a continuous structure that is flexible instead of rigid and the cut out 207 is completely optional or could be in any configuration. View Redirecting System 200 could be molded or fabricated in one piece including reflective surfaces 205 and 202. View Redirecting System 200 can be mounted from any surface of this device including back side of first reflective surface 202, or back side of second reflective surface 205 or any portion of continuous structure 204; Camera Assembly can include a separate display screen 301 and separate video camera 302; camera assembly could alternatively include tablet computers, hand held smart phones, or other smart device. Video camera 302 can be located distal or proximal to the display screen 301 and either item can be mounted anywhere on the mobility device; camera assembly could alternatively have a tray or holder mounted on the mobility device that camera device could be dropped into so that it could easily be added or removed. A View Redirecting System can be used in the bicycle 231 application and can be mounted in any viewable location on the bicycle; means of mounting the view redirecting system 100 or view redirecting system 200 or video camera assembly 300 are not limited to the suggested methods listed.

The above description of variations of the invention is merely demonstrative in nature and, thus, variations thereof are not to be regarded as a departure from the spirit and scope of the inventions disclosed within this document.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A view redirecting system for use with a mobility device comprising,
a first structure having a convex first reflective surface,
a second structure having a flat second reflective surface, and
a third structure,
said third structure being one of a nonadjustable and a adjustable structure and configured for connecting said first and second structures together as a unit,
wherein said first structure and said second structure are configured to be positioned with respect to each other such that said first reflective surface and said second reflective surface are facing each other at angle up to and including ninety degrees, said third structure being configured to maintain said angle,
wherein the view redirecting system is constructed and arranged to redirect a user's view from a first line-of-sight to a second line-of-sight by light interacting with said reflective surfaces,
the view redirecting system being configured for both attachment to and detachment from a structural member of the mobility device,
whereby, a user's view car. be redirected to a more favorable orientation when using the mobility device.

21. The view redirecting system as set forth in claim 20 wherein said third
structure is adjustable and including at least one hingeable assembly having at
least one hinge joint for adjustment of said angle, said at least one hingeable
assembly having at least one movable member to maintain said angle

22. The view redirecting system as set forth in claim 21 wherein said at least one hingeable assembly has two hinge joints spaced apart from each other having interconnecting linkage for further articulation of said first and second structures with respect to each other and a corresponding second moveable member to maintain said angle.

23. The view redirecting system as set forth in claim 21 wherein said at least one hingeable assembly has two spaced apart hingeable assemblies to provide further support between said first and second structures.

24. The view redirecting system as set forth in claim 20 wherein said attachment to and detachment from a structural member is accomplished by a mounting device.

25. The view redirecting system as set forth in claim 24 including a hingeable assembly having a hinge joint, said hingeable assembly being attached to said second structure and said mounting device, said hingeable assembly providing adjustment of said second structure with respect to said mounting device, said hingeable assembly having at least one movable member to lock said hinge joint at a set adjustment.

26. The view redirecting system as set forth in claim 24, wherein said mounting device being at least one of a clamp, magnet, bolt assembly, screw, grip, adhesive and similar fastener constructed and arranged to accomplish said attachment to and detachment from a structural member.

27. The view redirecting system as set forth in claim 20, wherein said third structure is continuous and wherein said nonadjustable structure is rigid structure and said adjustable structure is reshapeable structure.

28. The view redirecting system as set forth in claim 20 further including an extension arm, said extension arm constructed and arranged for interconnection of the view redirection system to said structural member, said extension arm having an extended length to displace the view redirecting system apart from said structural member.

29. The view redirecting system as set forth in claim 20 wherein the mobility device is one of a walker, rollator and a wheelchair.

30. The view redirecting system as set forth in claim 20 wherein the mobility device is a bicycle.

31. A view redirecting system for use with a mobility device comprising,
a first structure having a convex first reflective surface,
a second structure having a flat second reflective surface, and
a third structure,
said third structure is adjustable and configured for connecting said first and second structures together as a unit,
wherein said first structure and said second structure are configured to be positioned with respect to each other such that said first reflective surface and said second reflective surface are facing each other at angle up to and including ninety degrees, said third structure being configured to maintain said angle,
wherein said third structure includes at least one hingeable assembly having at least one hinge joint for adjustment of said angle, said at least one hingeable assembly having at least one movable member to maintain said angle.
wherein the view redirecting system is constructed and arranged to redirect a user's view from a first line-of-sight to a second line-of-sight by light interacting with said reflective surfaces,
wherein the view redirecting system includes a pivotable mounting device attached with said second structure configured for both attachment to and detachment from a structural member of the mobility device,
whereby, a user's view can be redirected to a more favorable orientation when using the mobility device.

32. The view redirecting system as set forth in claim 31 further including
an extension arm, said extension arm constructed and arranged for
interconnection of the view redirection system to said structural member, said extension arm having an extended length to displace the view redirecting system apart from said structural member.

33. A view redirecting system for use with a mobility device comprising,
a video camera assembly having,
a video display screen and
a video camera, said display screen and said camera being both in electronic and mechanical communication with each other,
a mounting device,
wherein the view redirecting system is constructed and arranged such that input views to said camera are redirected and presented by said display to a user, wherein the line-of-sights of the camera and display are at an angle with respect to each other thereby, redirecting a user's view from a first line-of-sight to a second line-of-sight, said angle being secured by adjustable structure,
wherein said mounting device is in communication with said display and configured for both the view redirecting system's attachment to and detachment from a structural member of the mobility device,
whereby, a user's view can be redirected to a more favorable orientation when using the mobility device.

34. The view redirecting system as set forth in claim 33, wherein said mounting device being at least one of a clamp, magnet, bolt assembly, screw, grip, adhesive and similar fastener constructed and arranged to accomplish said attachment to and detachment from a structural member.

35. The view redirecting system as set forth in claim 33 including a hingeable assembly having a hinge joint, said hingeable assembly being attached to said display and said mounting device, said hingeable assembly providing adjustment of said display with respect to said mounting device, said hingeable assembly having at least one movable member to lock said hinge joint at a set adjustment.

36. The view redirecting system as set forth in claim 33 further including an extension arm, said extension arm constructed and arranged for interconnection of the view redirection system to said structural member, said extension arm having an extended length to displace the view redirecting system apart from said structural member.

37. The view redirecting system as set forth in claim 33, wherein said camera and said display can be mounted apart from each other on different structural members of said mobility device.

38. The view redirecting system as set forth in claim 33, wherein said camera has a wide angle input lens.

39. The view redirecting system as set forth in claim 33, wherein said mobility device is one of a walker, rollator, bicycle and a wheelchair.
